(19) United States
(12) Patent Application Publication
(10) Pub. No.: US 2009/0215007 A1
(43) Pub. Date: Aug. 27, 2009

(54) Dental implant with porous trabecular structure

(76) Inventors: Richard Caterini, Orlienas (FR); Robert Fromental, Lyon (FR); Daniel Cantaloube, Versailles (FR)

Correspondence Address: CLARK & BRODY, 1090 VERMONT AVENUE, NW, SUITE 250, WASHINGTON, DC, 20005, US

(21) Appl. No.: 11/919,828

(22) PCT Filed: May 4, 2005
(86) PCT No.: PCT/FR2005/001123

§ 371 Date: Feb. 27, 2009

(51) Int. Cl. A61C 8/00

(52) U.S. Cl. 433/173

(57) ABSTRACT

The invention relates to a dental implant comprising a biocompatible porous mass in which is arranged at least one receiving bore (8) for a linking piece of a dental prosthesis, characterised in that the biocompatible porous mass (2) is constituted by a single material of trabecular structure ensuring communication between the exterior of said porous mass and the internal of said porous mass.

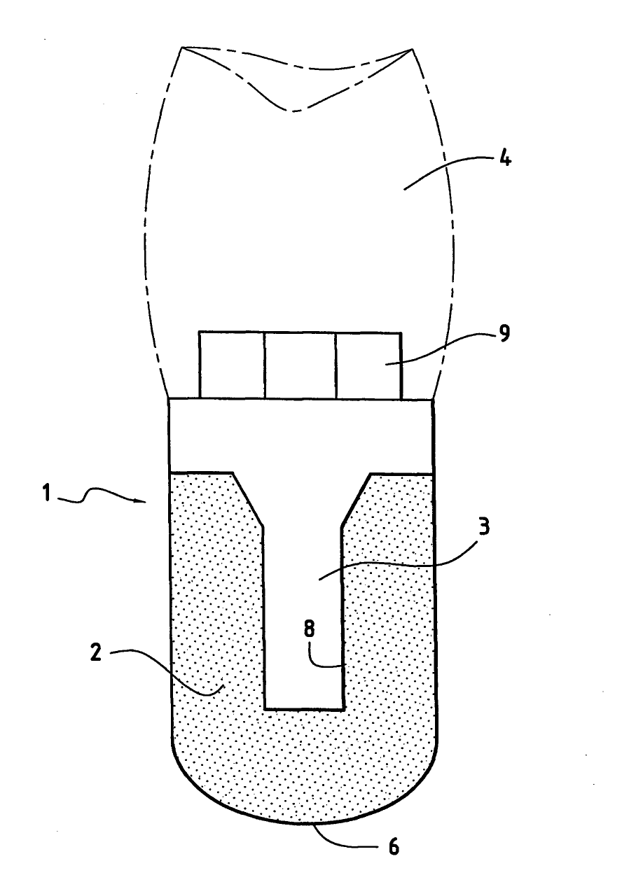

The present invention relates to a biocompatible monomaterial dental implant having particularly rapid integration in the surrounding bone.

The aim of the present invention more particularly is a dental implant suitable for being adapted to a dental prosthesis.

The present invention thus relates to a dental implant which can be used for purposes of plastic surgery, especially as a maxillo facial implant for placing in certain cases, as well as its prosthesis, during the same surgical procedure.

A dental implant is utilised for making a removable and/or fixed dental prosthesis, with a view to restoring chewing function, buccal comfort, and aesthetics for a patient with some or all teeth missing. In the maxilla or in the mandible of a patient the implant creates anchorings which are stable, resistant, efficacious, non-iatrogenic and durable.

Most frequently, the implant is a piece in the form of a cylindrical or tapered peg, fitted with external an thread, a bore or well provided with an internal thread, and a head with an imprint at one of its ends. The external thread is optionally self-tapping and enables direct insertion of the implant by screwing into the bone of the upper or lower jaw of the patient. The internal bore helps position a prosthetic system on the implant, also known as false stump, by screwing into the internal thread. The false stump then receives the dental crown projecting into the buccal cavity.

The classic artificial root made from a metallic powder has a relatively limited shelf life, since the solidity of the implant is insufficient in the absence of any resistant structure. This artificial root is likewise fragile, since its form cannot ensure equal distribution of the pressure from chewing.

The patent FR 2 747 031 describes implants, embedded or not embedded, made of solid titanium whereof the more or less shaped model is intended for improving consolidation in the bone of the maxilla or mandible. Radial piercings and root faces are made to the side of the end implanted in the bone. Such implants allow for good positioning precision but are not very favourable for good bone consolidation.

Another design of an implant is based on the presence of a structuring and resistant axle, for example made of shape-memory alloy, surrounded by various coatings, including a rugged outer coating, for example made of sprayed metal, hydroxyapatite for example. But the lack of cohesion between the different layers frequently leads to deterioration of the rugged or porous external coating when it is being put in place.

If these conceptions are favourable to bone consolidation by the presence of porous elements, they are often difficult to implant near the bone, because their geometry obliges them to provide considerable clearance between the implant and the osseous cavity prepared for receiving it.

The patent FR 2 796 265 describes an implant made especially of solid metallic shape-memory NiTi, covered in an external layer made of a second porous metal. But in such an alloy, the nickel can be toxic in case of salting out.

The object of the invention aims to rectify the drawbacks of the prior art by proposing a dental implant rapidly integrated into the osseous system of the upper maxilla and mandible, to be able to set this implant, and optionally that of the corresponding prosthesis, during the same surgical procedure.

To achieve such an objective, the object of the invention relates to a dental implant comprising a porous biocompatible mass in which is arranged at least one receiving bore for an intermediate piece on which the dental prosthesis is fixed. According to the invention, the porous biocompatible mass is constituted by a single material of trabecular structure ensuring communication between the exterior of said porous mass and the interior of said porous mass.

According to a first variant embodiment, the biocompatible porous mass is constituted by porous titanium.

According to a second variant embodiment, the biocompatible porous mass is constituted by porous tantalum.

According to a third variant embodiment, the biocompatible porous mass is constituted by porous NiTi.

According to a preferred characteristic, the biocompatible porous mass has an open porosity of between 17% and 87% with pore dimensions ranging from 75 μm to 500 μm.

Advantageously, the external dimensions of the porous mass, embedded in the bone mass, correspond to those of the bore made in the bone mass of the maxilla or the mandible.

According to a variant embodiment, the porous mass comprises an external thread for blocking said implant in the osseous receptacle.

According to a characteristic of the invention, the porous mass comprises a penetration end facilitating penetration of said implant into the bone mass.

Various other characteristics will emerge from the following description in reference to the sole FIGURE schematically illustrating a dental prosthesis comprising a dental implant according to the invention.

As is evident from the sole FIGURE, the dental prosthesis 1 is designed to replace a totally missing tooth. This dental prosthesis 1 comprises a dental implant 2 according to the invention on which is fixed a linking piece 3 ensuring positioning of a false stump and a crown 4, for example made of ceramic or enamelled metal, corresponding to the form of the tooth to be replaced.

In classic terms, the dental implant 2 has a general cylindrical or tapered form, having a penetration end 6 which first enters the in the jawbone when the implant 2 is being surgically set. The penetration end 6 has, for example, a rounded, oblong, tapered or pointed form. The dental implant 2 comprises at least one well or a blind central bore 8 for receiving the linking piece 3 and opening at the opposite end of the perforation end 6. For instance, the linking piece 3 is provided with a polygonal head 9 for positioning the crown 4.

In keeping with the invention, the dental implant 2 is made from a biocompatible porous mass constituted by a single material of trabecular structure. It must be understood that such a biocompatible porous mass thus has a network of intercommunicating channels ensuring communication between the exterior and the interior of the porous mass. In the example illustrated, the trabecular structure opens between the external surface of the dental implant and the central bore 8.

It therefore eventuates that this open-pore trabecular structure accelerates colonisation of the implant for bone tissue and after consolidation, forming a close bond between the bone mass and the core itself of the dental implant. Osteoblastic colonisation is very rapid.

According to a first variant embodiment, the biocompatible porous mass 2 is constituted by porous titanium.

According to another variant embodiment, the biocompatible porous mass 2 is constituted by porous tantalum.

According to another variant, the biocompatible porous mass 2 is constituted by porous NiTi.

According to a preferred characteristic, the porous material making up the biocompatible porous mass 2 has an open porosity of between 17% and 87% with pore dimensions from 75 μm to 500 μm.

The porous material can be obtained in different ways, especially by plasma projection, compacting and/or sintering techniques allowing the use of powders, or again by deposition, either in vapour phase (physico-chemical process in vapour phase by plasma projection), or in electrolyte solution (galvanoplasty or electrodeposition process).

The alveolar constitution of the material itself confers on the implanted piece characteristics having a sculpting effect, at the time of implantation fulfilling the function of auto thread.

In certain surgical cases where the bone density is very high, the body of the implant 2 can be provided with an external thread making it easy to screw the implant into the bone mass, in turn facilitating blockage of the latter in a good position, such that a prosthesis can be mounted during the same chirurgical procedure, however definitive consolidation takes place in the weeks following said procedure.

The external dimensions of the porous mass 2 embedded in the bone mass correspond to those of the bore made in the bone mass of the maxilla or mandible. The form of the porous mass 2 is adapted to each patient.

The biocompatible porous mass 2 comprises a bore 8 threaded or not, for receiving the linking piece 3 provided with a thread to ensure that the implant is integral with the prosthesis.

The invention is not limited to the examples as described and illustrated, as diverse modifications can be made without departing from its scope.

1. A dental implant comprising a biocompatible porous mass in which is arranged at least one receiving bore (8) for a linking piece of a dental prosthesis, characterised in that the biocompatible porous mass (2) is constituted by a single material of trabecular structure ensuring communication between the exterior of said porous mass and the internal of said porous mass.

2. The dental implant as claimed in claim 1, characterised in that the biocompatible porous mass (2) is constituted by porous titanium.

3. The dental implant as claimed in claim 1, characterised in that the biocompatible porous mass (2) is constituted by porous tantalum.

4. The dental implant as claimed in claim 1, characterised in that the biocompatible porous mass (2) is constituted by porous NiTi.

5. The dental implant as claimed in claim 1, characterised in that the biocompatible porous mass (2) has an open porosity of between 17% and 87% with pore dimensions from 75 μm to 500 μm.

6. The dental implant as claimed in claim 1, characterised in that the external dimensions of the porous mass (2), embedded in the bone mass, correspond to those of the bore made in the bone mass of the maxilla or the mandible.

7. The dental implant as claimed in claim 1, characterised in that the porous mass (2) comprises an external thread intended to block said implant in the osseous receptacle.

8. The dental implant as claimed in claim 1, characterised in that the porous mass (2) comprises a penetration end (6) facilitating penetration of said implant in the bone mass.

9. Corporal dental prosthesis, characterised in that it comprises a dental implant as claimed in claim 1, fitted with a linking piece (3) for receiving a crown (4).

10. The dental implant as claimed in claim 2, characterised in that the biocompatible porous mass (2) has an open porosity of between 17% and 87% with pore dimensions from 75 μm to 500 μm.
